(19) United States
(12) Patent Application Publication
(10) Pub. No.: US 2013/0133515 A1
(43) Pub. Date: May 30, 2013

(54) Separation of Acidic Constituents by Self Assembling Polymer Membranes

(71) Applicants: Scott T. Matteucci, Midland, MI (US); Leonardo C. Lopez, Midland, MI (US); Shawn D. Feist, Midland, MI (US); Peter N. Nickias, Midland, MI (US); William J. Harris, Lake Jackson, TX (US)

(72) Inventors: Scott T. Matteucci, Midland, MI (US); Leonardo C. Lopez, Midland, MI (US); Shawn D. Feist, Midland, MI (US); Peter N. Nickias, Midland, MI (US); William J. Harris, Lake Jackson, TX (US)

(73) Assignee: DOW GLOBAL TECHNOLOGIES LLC, Midland, MI (US)

(21) Appl. No.: 13/577,582

(22) PCT Filed: Feb. 11, 2011
(86) PCT No.: PCT/US11/24529

§ 371 Date: Feb. 6, 2013

Related U.S. Application Data
(60) Provisional application No. 61/304,086, filed on Feb. 12, 2010.
(60) Provisional application No. 61/348,048, filed on May 25, 2010.

(51) Int. Cl. B01D 71/48; B01D 71/56; B01D 71/54; B01D 53/22; B01D 71/52

(52) U.S. Cl. CPC B01D 71/48; B01D 53/228; B01D 71/52; B01D 71/54; B01D 71/56
USPC 95/49; 95/45; 95/51

(57) ABSTRACT

A method of removing an acidic gas from a gas stream by contacting said gas stream with a polymer, wherein the polymer is a macromolecularly self assembling polymeric material, the method including the steps of contacting the gas mixture with the membrane; and extracting the acidic gas from the gas stream.

### FIELD OF THE INVENTION

The invention relates generally to methods for separating acidic constituents of gas vapors. More specifically, the invention relates to methods for the extraction of acidic constituents from gaseous streams, such as well head gases or flue/exhaust gases through use of membranes having a macromolecular self assembling polymer.

### BACKGROUND OF THE INVENTION

Legislation is already in place or being considered for many countries to regulate emissions of greenhouse gases, such as CO₂. Early markets in CO₂ capture already exist in Canada and Europe with rapid market expansion expected if carbon reductions are mandated in other parts of the world. Based on internal and external emissions trading as of mid-2000, the price for CO₂ credits has been approximately $10/ton. Even at that relatively low cost for CO₂ credits, the market based on projected CO₂ emissions and the Kyoto Protocol targets yields a 2010 market of $30 BB. In addition, the International Energy Agency's (IEA) forecast of CO₂ prices and emissions estimates carbon capture and sequestration could be a $250 billion-$1.8 trillion industry by 2050, depending upon emission penalties. For example, Norway has legislated a tax of $65/ton of CO₂ emitted. The potential market size for CO₂ separations makes addressing this need commercially attractive.

Currently, liquid amine absorbents are the best option for CO₂ capture, however this technology is economical only under specific circumstances due to high solvent regeneration costs. Although current amine technology provides an immediate solution in CO₂ post-combustion and natural gas markets, CO₂ separations in growing and physically larger markets, such as flue gas capture from coal-fired power plants, require reduction of the amount of energy required to perform the desired separation and to remain economically viable.

Examples of certain membrane systems include those disclosed by Staudt-Bickel, W. J. Koros, titled Improvement of CO₂/CH₄ separation characteristics of polyimides by chemical crosslinking, Journal of Membrane Science, 1999, 155, p. 145-154, which presents the use of a crosslinked Uitem 1000® as a method for mitigating CO₂ induced plasticization.

Further, H. Lin, E. Van Wagner, R. Raharjo, B. D. Freeman, I. Roman; High-performance polymer membranes for natural-gas sweetening; Advanced Materials, 2006, 18, p. 39-44 discloses the use of crosslinked poly(ethylene oxide) as a matrix material for natural gas sweetening. This material has high CO₂ permeability, CO₂/CH₄ selectivity, and is at least somewhat resistant to CO₂ induced plasticization

Hale, et al, U.S. Pat. No. 7,368,511, Polymer blends with improved rheology and improved unnotched impact strength, discloses a biodegradable copolyester polymer blended with polylactic acid.

Koros et al, U.S. Pat. No. 7,247,191, Crosslinked and crosslinkable hollow fiber membrane and method for make same utility. This patent teaches the use of a polyimide that is crosslinked in order to suppress CO₂ induced plasticization and the use of this material as a hollow fiber membrane.

The separation of acid gases from mixtures with non-polar gases is important in many industrial applications. Unfortunately, there are not many materials that satisfactorily demonstrate acid gas selectivity and permeability.

For instance, removing CO₂ from natural gas, a process referred to as natural gas sweetening, requires both a high CO₂ permeability (i.e., flux) and CO₂/CH₄ selectivity. Currently, most natural gas is purified via more conventional technologies such as amine scrubbing. However, these technologies are only economical on very productive gas wells.

Polymeric membranes are often used for natural gas on low pressure or low productivity gas wells. Both cellulose acetate and Ultem 1000® are currently used in natural gas sweetening, but both of these materials suffer from selectivity instability when exposed to CO₂ at high CO₂ partial pressure, as can be expected with natural gas wells. This creates a demand for new polymer membranes that can provide the gas transport properties required for natural gas sweetening in real world environments.

As a result, there is a need for methods for separating acidic gases in various environments with materials having the appropriate acid gas selectivity and permeability.

### SUMMARY OF THE INVENTION

In accordance with one aspect of the invention, there is provided a method of removing an acidic gas from a gas stream with a polymer, wherein the polymer comprises a macromolecularly self assembling polymeric material, the method comprising the steps of a.) contacting said gas mixture with said membrane; and b.) extracting said acidic gas from said gas stream.

Gas permeation through nonporous polymers is usually described using the so-called 3-step “solution-diffusion” model. According to this model, gas molecules at the upstream (i.e., high partial pressure) membrane surface partition into the upstream face of the polymer. The gas molecules diffuse through the polymer and desorb from the polymer surface exposed to low gas partial pressure. The second step in this process, diffusion through the polymer, is the rate limiting step.

The steady state permeability of a gas A, P_{A}, through a homogenous, isotropic flat sheet membrane of thickness l is defined as follows:

$${P}_{A} ≡ \frac{{N}_{A} 1}{( {p}_{2} - {p}_{1} )} \qquad ( 1 )$$

where N_{A} is the steady state gas flux through the film, and p₂ and p₁ are the feed and permeate partial pressures of gas A, respectively. Permeability is typically treated as an intrinsic property of a polymer penetrant system, and it is often reported in units of barrer, where:

1 barrer≡10⁻¹⁰ cm³(STP)cm/(cm² s(cm Hg))

At steady state, when Fick's first law of diffusion governs the gas transport and when the downstream pressure, p₁, is much lower than the upstream pressure, p₂, Eq. (1) may be expressed as follows:

P_{A}=D_{A}×S_{A} (2)

where D_{A} is the effective concentration-averaged diffusion coefficient, and S_{A} is the solubility coefficient at the upstream face of the membrane:

S_{A}=C₂/p₂ (3)

where C₂ is the gas concentration in the polymer at the upstream film surface, and p₂ is the permeate partial pressure of gas A in the feed. Gas solubility in polymers often increases as some measure of gas condensability increases, such as critical temperature. Critical temperature, T_{c}, values for several gases of interest are presented below. CO₂ has, by far, the highest critical temperature among these gases. Since gas solubility in polymers scales exponentially with T_{c}, CO₂ will generally be much more soluble in polymers than these other gases, which increases the tendency of polymers to be more permeable to CO₂ than many other gases.

TABLE 1

| | Kinetic Diameter | Critical |
|---|---|---|
| Penetrant | (A) | Temperature (K |
| CO₂ | 3.3 | 304.2 |
| N₂ | 3.64 | 126.2 |
| CH₄ | 3.8 | 190.6 |

Diffusion coefficients characterize the mobility of a penetrant molecule in a polymer, and they often correlate with penetrant size as measured by, for example, kinetic diameter, with smaller molecules having higher diffusion coefficients. The preceding table provides penetrant sizes, based on kinetic diameter, for some gases of interest in CO₂ separations. The CO₂ kinetic diameter is less than that of N₂ and CH₄ gas in this list, reflecting the oblong nature of CO₂. Like other anisotropically-shaped molecules, CO₂ is believed to execute diffusion steps predominantly in the direction of its narrowest cross-section. Consequently, CO₂ diffusion coefficients in polymers are usually higher than those of gases of considerably lower molecular weight (e.g., CH₄ or N₂). The ability of a polymer to separate two gases is often defined in terms of the ideal selectivity, α_{A/B}, which is the ratio of permeabilities of the two gases:

$${α}_{A / B} ≡ \frac{{P}_{A}}{{P}_{B}} \qquad ( 4 )$$

From Eq. (2), the ideal selectivity is the product of D_{A}/D_{B}, the diffusivity selectivity, and S_{A}/S_{B}, the solubility selectivity:

$${α}_{A / B} = \frac{{D}_{A}}{{D}_{B}} \times \frac{{S}_{A}}{{S}_{B}} \qquad ( 5 )$$

Diffusivity selectivity depends primarily on the relative size of penetrant molecules and the size-sieving ability of a polymer (i.e., the ability of a polymer to separate gases based on penetrant size), which depends strongly on polymer matrix free volume (and free volume distribution) as well as polymer chain rigidity. Solubility selectivity is influenced by the relative condensability of the penetrants and the relative affinity of the penetrants for the polymer matrix. As indicated earlier, penetrant condensability is often a dominant factor in determining solubility and, therefore, solubility selectivity. However, CO₂ is a polar penetrant and, as such, can have favorable interactions with polar groups in the polymer, thereby altering its solubility and solubility selectivity above and beyond penetrant condensability considerations alone.

### BRIEF DESCRIPTION OF THE DRAWING

The FIGURE is a Schematic depiction of the apparatus used in Working Example 3.

### DETAILED DESCRIPTION OF THE PREFERRED EMBODIMENTS

In accordance with the invention, there is provided a method of extracting an acidic gas from a gas stream through a polymeric material. The polymeric material comprising a polymer being a macromolecular self assembling polymeric material. The method includes the steps of contacting the gas mixture with the membrane and extracting the acidic gas from the gas stream.

### Macromolecular Self Assembling Material

As used herein a macromolecular self-assembling polymers (MSA) means an oligomer or high polymer that effectively forms larger associated or assembled oligomers and/or polymers through the physical intermolecular associations of chemical functional groups. Without wishing to be bound by theory, it is believed that the intermolecular associations do not increase the molecular weight (Mn—Number Average molecular weight) or chain length of the self-assembling material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a molecularly self-assembling material.

Accordingly, in preferred embodiments MSAs exhibit mechanical properties similar to some higher molecular weight synthetic polymers and viscosities like very low molecular weight compounds. However, it is possible to have a macromolecular self-assembling polymer that is of high molecular weight and of high viscosity and as such would be within the scope of this invention. MSA organization (self-assembly) is caused by non-covalent bonding interactions, often directional, between molecular functional groups or moieties located on individual molecular (i.e., oligomer or polymer) repeat units (e.g., hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or van der Waals forces and can occur intra- and intermolecularly to impart structural order.

One preferred mode of self-assembly is hydrogen-bonding and this non-covalent bonding interactions is defined by a mathematical “Association constant,” K (assoc) constant describing the relative energetic interaction strength of a chemical complex or group of complexes having multiple hydrogen bonds. Such complexes give rise to the higher-ordered structures in a mass of MSA materials. A description of self assembling multiple H-bonding arrays can be found in “Supramolecular Polymers,” Alberto Ciferri Ed., 2nd Edition, pages (pp) 157-158.

A “hydrogen bonding array” is a purposely synthesized set (or group) of chemical moieties (e.g., carbonyl, amine, amide, hydroxyl, etc.) covalently bonded on repeating structures or units to prepare a self assembling molecule so that the individual chemical moieties preferably form self assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. In preferred embodiments, the arrays are chemically the same or different and form complexes.

Accordingly, the molecularly self-assembling materials (MSA) suitable for membrane applications presently include: molecularly self-assembling polyesteramides, copolyesteramide, copolyetheramide, copolyetherester-amide, copolyetherester-urethane, copolyether-urethane, copolyester-urethane, copolyester-urea, copolyetherester-urea and their mixtures. Preferred MSA include copolyesteramide, copolyetherester-amide, copolyether-amide, copolyester-urethane, and copolyether-urethanes. The MSA preferably has number average molecular weights, MWₙ (interchangeably referred to as Mₙ) (as is preferably determined by NMR spectroscopy or optionally gel permeation chromatography (GPC)) of 2000 grams per mole or more, more preferably at least about 3000 g/mol, and even more preferably at least about 5000 g/mol. The MSA preferably has MWₙ 1,000,000 g/mol or less, more preferably about 50,000 g/mol or less, and even more preferably about 25,000 g/mol or less.

The MSA material preferably comprises molecularly self-assembling repeat units, more preferably comprising (multiple) hydrogen bonding arrays, wherein the arrays have an association constant K (assoc) preferably from 10² to 10⁹ reciprocal molarity (M⁻¹) and still more preferably greater than 10³ M⁻¹; association of multiple-hydrogen-bonding arrays comprising donor-acceptor hydrogen bonding moieties is the preferred mode of self assembly. The multiple H-bonding arrays preferably comprise an average of 2 to 8, more preferably 4-6, and still more preferably at least 4 donor-acceptor hydrogen bonding moieties per molecularly self-assembling unit. Molecularly self-assembling units in preferred MSA materials include bis-amide groups, and bis-urethane group repeat units and their higher oligomers.

Preferred self-assembling units in the MSA material useful in the present invention are bis-amides, bis-urethanes and bis-urea units or their higher oligomers. For convenience and unless stated otherwise, oligomers or polymers comprising the MSA materials may simply be referred to herein as polymers, which includes homopolymers and interpolymers such as copolymers, terpolymers, etc.

In some embodiments, the MSA materials include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g., phenyl) in the backbone of the oligomer or polymer repeating units. In some embodiments, non-aromatic hydrocarbylene groups are optionally substituted with various substituents, or functional groups, including but not limited to: halides, alkoxy groups, hydroxyl groups, thiol groups, ester groups, ketone groups, carboxylic acid groups, amines, and amides. A “non-aromatic heterohydrocarbylene” is a hydrocarbylene that includes at least one non-carbon atom (e.g., N, O, S, P or other heteroatom) in the backbone of the polymer or oligomer chain, and that does not have or include aromatic structures (e.g., aromatic rings) in the backbone of the polymer or oligomer chain.

In some embodiments, non-aromatic heterohydrocarbylene groups are optionally substituted with various substituents, or functional groups, including but not limited to: halides, alkoxy groups, hydroxyl groups, thiol groups, ester groups, ketone groups, carboxylic acid groups, amines, and amides. Heteroalkylene is an alkylene group having at least one non-carbon atom (e.g., N, O, S or other heteroatom) that, in some embodiments, is optionally substituted with various substituents, or functional groups, including but not limited to: halides, alkoxy groups, hydroxyl groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. Cycloalkyl and cycloalkylene groups independently are monocyclic or polycyclic fused systems as long as no aromatics are included. Examples of carbocylclic radicals include cyclopropyl, cyclobutyl, cyclopentyl, cyclohexyl and cycloheptyl.

In some embodiments, the groups herein are optionally substituted in one or more substitutable positions as would be known in the art. For example in some embodiments, cycloalkyl and cycloalkylene groups are optionally substituted with, among others, halides, alkoxy groups, hydroxyl groups, thiol groups, ester groups, ketone groups, carboxylic acid groups, amines, and amides. In some embodiments, cycloalkyl and cycloalkene groups are optionally incorporated into combinations with other groups to form additional substituent groups, for example: “-Alkylene-cycloalkylene-,” “-alkylene-cycloalkylene-alkylene-,” “-heteroalkylene-cycloalkylene-,” and “-heteroalkylene-cycloalkyl-heteroalkylene” which refer to various non-limiting combinations of alkyl, heteroalkyl, and cycloalkyl. These combinations include groups such as oxydialkylenes (e.g., diethylene glycol), groups derived from branched diols such as neopentyl glycol or derived from cyclo-hydrocarbylene diols such as Dow Chemical's UNOXOL® isomer mixture of 1,3- and 1,4-cyclohexanedimethanol, and other non-limiting groups, such -methylcylohexyl-methyl-cyclohexyl-methyl-, and the like.

“Heterocycloalkyl” is one or more cyclic ring systems having 4 to 12 atoms and, containing carbon atoms and at least one and up to four heteroatoms selected from nitrogen, oxygen, or sulfur. Heterocycloalkyl includes fused ring structures. Preferred heterocyclic groups contain two ring nitrogen atoms, such as piperazinyl. In some embodiments, the heterocycloalkyl groups herein are optionally substituted in one or more substitutable positions. For example in some embodiments, heterocycloalkyl groups are optionally substituted with halides, alkoxy groups, hydroxyl groups, thiol groups, ester groups, ketone groups, carboxylic acid groups, amines, and amides.

Examples of MSA materials useful in the present invention are poly(ester-amides), poly(ether-amides), poly(ester-ureas), poly(ether-ureas), poly(ester-urethanes), and poly(ether-urethanes), and mixtures thereof that are described, with preparations thereof, in U.S. Pat. No. 6,172,167; and applicant's co-pending PCT application numbers PCT/US2006/023450, which was renumbered as PCT/US2006/004005 and published under PCT International Patent Application Number (PCT-IPAPN) WO 2007/099397; PCT/US2006/035201, which published under PCT-IPAPN WO 2007/030791; PCT/US08/053917; PCT/US08/056754; and PCT/US08/065242. Preferred said MSA materials are described below.

In a set of preferred embodiments, the molecularly self-assembling material comprises ester repeat units of Formula I:

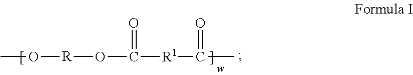

and at least one second repeat unit selected from the esteramide units of Formula II and III.

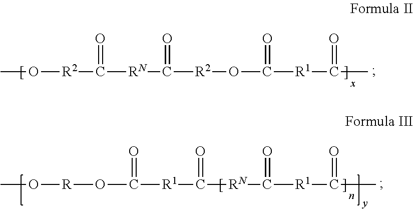

and the ester urethane units of Formula IV:

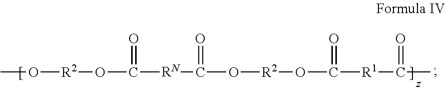

wherein

R is at each occurrence, independently a C₂-C₂₀ non-aromatic hydrocarbylene groups, a C₂-C₂₀ non-aromatic heterohydrocarbylene groups, or a polyalkylene oxide group having a group molecular weight of from about 100 to about 15,000 g/mol. In a preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups). Preferably, these aforementioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -heteroalkylene-, -heteroalkylene-cycloalkylene-, -cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example the moiety from diethylene glycol (—CH₂CH₂OCH₂CH₂—). When R is a polyalkylene oxide group it preferably is a polytetramethylene ether, polypropylene oxide, polyethylene oxide, or their combinations in random or block configuration wherein the molecular weight (Mn—average molecular weight, or conventional molecular weight) is preferably about 250 g/ml to 5000, g/mol, more preferably more than 280 g/mol, and still more preferably more than 500 g/mol, and is preferably less than 4000 g/mol; in some embodiments, mixed length alkylene oxides are included. Other preferred embodiments include species where R is the same C₂-C₆ alkylene group at each occurrence, and most preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, most preferably —(CH₂)₄—.

R² is at each occurrence, independently, a C₁-C₂₀ non-aromatic hydrocarbylene group. According to another embodiment, R² is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence —N(R³)—Ra—N(R³)—, where R³ is independently H or a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above. The letter w represents the ester mole fraction, and x, y, and z represent the amide or urethane mole fractions where w+x+y+z=1, 0<w<1, and at least one of x, y and z is greater than zero. n is at least 1 and has a mean value less than 2. Ra is a C₂-C₂₀ non-aromatic hydrocarbylene group, more preferably a C₂-C₁₂ alkylene: most preferred Ra groups are ethylene butylene, and hexylene —(CH₂)₆—. In some embodiments, R^{N} is piperazin-1,4-diyl. According to another embodiment, both R³ groups are hydrogen.

In an alternative embodiment, the MSA is a polymer of repeating units of either Formula II or Formula III, where R, R¹, R², R^{N}, and n are as defined above and x and y are mole fractions wherein x+y=1, and 0<x<1 and 0<y<1.

In certain embodiments comprising polyesteramides of Formula I and II, or Formula I, II, and III, particularly preferred materials are those wherein R is —(C₂-C₆)— alkylene, especially —(CH₂)₄—. Also preferred are materials wherein R¹ at each occurrence is the same and is C₁-C₆ alkylene, especially —(CH₂)₄—. Further preferred are materials wherein R² at each occurrence is the same and is —(C₁-C₆)— alkylene, especially —(CH₂)₅— alkylene. The polyesteramide according to this embodiment preferably has a number average molecular weight (Mn) of at least about 4000, and no more than about 50,000. More preferably, the molecular weight is no more than about 25,000.

For convenience the repeating units for various embodiments are shown independently. The invention encompasses all possible distributions of the w, x, y, and z units in the copolymers, including randomly distributed w, x, y, and z units, alternatingly distributed w, x, y and z units, as well as partially, and block or segmented copolymers, the definition of these kinds of copolymers being used in the conventional manner as known in the art. Additionally, there are no particular limitations in the invention on the fraction of the various units, provided that the copolymer contains at least one w and at least one x, y, or z unit. In some embodiments, the mole fraction of w to (x+y+z) units is between about 0.1:0.9 and about 0.9:0.1. In some preferred embodiments, the copolymer comprises at least 15 mole percent w units, at least 25 mole percent w units, or at least 50 mole percent w units.

In some embodiments, the number average molecular weight (Mₙ) of the MSA material useful in the present invention is between 1000 g/mol and 50,000 g/mol, inclusive. In some embodiments, Mₙ of the MSA material is between 2,000 g/mol and 25,000 g/mol, inclusive, preferably 5,000 g/mol to 12,000 g/mol.

### The Method of Use

In accordance with various embodiments of the method of the invention, the polymer may be synthesized and rendered as a film or sheet and placed as a membrane on a substrate, the substrate then being placed into a module and subjected to processing. During processing, the membrane is generally placed in contact with a gas stream and the acidic gas components are removed from the feed gas stream.

It will be appreciated that depending upon the source of the gas stream, the stream may comprise one or more acidic constituents. The method of the invention may be used to extract gaseous constituents, that is remove all or less than all of any acidic gaseous constituents present in the gas stream.

Representative gas streams to which the method of the invention may be applied include flue/exhaust gas streams, and well head gas streams among others.

The self assemblying polymeric material may be rendered in the form of a film or a multi layer sheet with our without a substrate and then used as a membrane in the extraction process. Representative substrates include any material useful with separation membranes including any symmetric or asymmetric hollow fiber material, and dense fiber spiral wound materials, among others. Useful substrates and modules include those disclosed in U.S. Pat. No. 5,486,430 issued Jan. 23, 1996; WO 2008/150586 published Dec. 11, 2008; and WO 2009/125217 published Oct. 15, 2009, all of which are incorporated herein by reference.

The polymer used in the method of the invention generally has a selectivity which varies depending upon constituent and flow rate. Useful CO₂/N₂ selectivities include those above 8, preferably above 14, and more preferably above 20 at CO₂ permeability above 10 barrer preferably above 15 barrer, and more preferably above 20 barrer at temperature and pressures of use. For well head applications, useful CO₂/CH₄ selectivities including those above 4, preferably above 6, and more preferably above 10 at CO₂ permeability above 10 barrer preferably above 15 barrer, and more preferably above 20 barrer at temperature and pressures of use. For instance, CO₂ permeability is 105 barrer and CO₂/N₂ ideal gas selectivity is 24.5 at 15 psig feed pressure and 35° C.

The method of the invention may be used to isolate and/or extract any variety of acidic gases including carbon gases such as carbon monoxide and carbon dioxide, as well as sulfur gases such as hydrogen sulfide, sulfur monoxide, sulfur dioxide and sulfur trioxide. These gases may also be removed from as a mixture of gases.

### WORKING EXAMPLES

The following Working Examples provide certain illustrative embodiments of the invention.

### Preparations

Preparation 1:

Preparation of MSA material that is a polyesteramide (PEA) comprising about 18 mole percent of ethylene-N,N′-dihydroxyhexanamide (C2C) monomer (the MSA material is generally designated as a PEA-C2C18%).

The following preparation is designed to give a PEA comprising 18 mol % of the C2C monomer. Into a 1-neck 500 mL round bottom flask is loaded titanium (IV) butoxide (0.31 g, 0.91 mmol), N,N′-1,2-ethanediyl-bis[6-hydroxyhexanamide] (C2C, 30.80 g, 0.1068 mol), dimethyl adipate (103.37 g, 0.5934 mol), and 1,4-butanediol (97.33 g, 1.080 mol). A stir-shaft and blade are inserted into the flask along with a modified Claisen adaptor with Vigreux column and distillation head. Apparatus is completed with stir bearing, stir motor, thermometer, take-off adaptor, receiver, heat-tracing and insulation, vacuum pump, vacuum regulator, nitrogen feed, and temperature controlled bath. Apparatus is degassed and held under positive nitrogen. Flask is immersed into a 160° C. bath with temperature raised to 175° C. for a total of 2 hours. Receiver is changed and vacuum is applied according to the following schedule: 5 minutes, 450 Torr (60 kiloPascals (kPa)); 5 minutes, 100 Torr; 5 minutes, 50 Torr; 5 minutes, 40 Torr; 10 minutes, 30 Torr; 10 minutes, 20 Torr; 1.5 hours, 10 Torr. Apparatus is placed under nitrogen, receiver changed, and placed under vacuum ranging over about 0.36 Torr to 0.46 Torr with the following schedule: 2 hours, 175° C.; 2 hours, to/at 190° C., and 3 hours to/at 210° C. Inherent viscosity=0.32 dL/g (methanol:chloroform (1:1 w/w), 30.0° C., 0.5 g/dL) to give the PEA-C2C18% of Preparation 1. By proton NMR in d4-acetic acid, Mₙ from end groups of the PEA-C2C18% of Preparation 1 is 11,700 g/mol. The PEA-C2C18% of Preparation 1 contains 17.3 mole % of polymer repeat units contain C2C.

Preparation 2:

Preparation of Terpolymer of C2C Polyesteramide. In a nitrogen atmosphere, titanium (IV) butoxide (0.091 g, 0.27 mmol), recrystallized N,N′-1,2-ethanediylbis(6-hydroxyhexanamide) (C2C) (22.25 g, 77.16 mmol), poly(ethylene glycol)-block-poly(propylene glycol)-block-poly(ethylene glycol) with 10 wt % polyethylene glycol, Mn 2800 (20.08 g, Aldrich/Pluoronic®L-81), dimethyl adipate (35.90 g, 0.2061 mol), and 1,4-butanediol (19.95 g, 0.2214 mol) are loaded into a 250 mL roundbottom flask. Into the flask is inserted a stir-shaft and blade, Claisen style distillation head with Vigreux column, stir bearing, along with a take-off adaptor and a collection receiver attached. Apparatus is degassed with three vacuum/nitrogen cycles before being left under nitrogen. Distillation head is heat-traced and flask is immersed into 160° C. bath with bath set point raised to 175° C. with a total of 2 hours from 160° C. to 175° C. Over a period of about 2.4 hours, pressure is lowered stepwise and held at 10 Torr. Apparatus is kept under full vacuum (˜0.3 to 0.6 Torr) for a total of about 6.5 hours and the bath temperature is increased after about 2 hours to 190° C. and subsequently increased after about 2 hours to 210° C., and held at 210° C. for about 2.5 hours. Product inherent viscosity=0.406 dL/g (0.5 g/dL, 30.0° C., chloroform/methanol (1/1, w/w)). By DSC, 10° C./min, rescan, Tg=67° C.; Tm=66, 123° C. (˜21 J/g).

Proton nuclear magnetic resonance spectroscopy (proton NMR or ¹H-NMR) is used to determine monomer purity, copolymer composition, and copolymer number average molecular weight Mₙ utilizing the CH₂OH end groups. Proton NMR assignments are dependent on the specific structure being analyzed as well as the solvent, concentration, and temperature utilized for measurement. For ester amide monomers and co-polyesteramides, D₄-acetic acid is a convenient solvent and is the solvent used unless otherwise noted.

### Pure Gas Testing Apparatus and Procedure

Apparatus: Obtain a gas permeation cell (Stainless Steel In-Line Filter Holder, 47 millimeters (mm), catalog number XX45 047 00 from Millipore Corporation). The gas permeation cell comprises a horizontal metal mesh support and a spaced-apart inlet and outlet respectively above and below the metal mesh support. The gas permeation cell together with a plaque being disposed on the metal mesh support, defines an upstream volume and a downstream volume. The inlet is in sequential fluid communication with the upstream volume, entrance face of the plaque, exit face of the plaque, downstream volume, and outlet. Also obtain a constant-volume variable-pressure pure gas permeation apparatus is similar to that described in reference FIG. 7.109 of Wiederhorn, S., et al., Mechanical Properties in Springer-Handbook of Materials Measurement Methods; Czichos, H., Smith, L. E., Saito, T., Eds.; Springer: Berlin, 2005; pages 371-397, which is incorporated herein by reference. All samples were exposed to vacuum for at least 16 hours at the test temperature prior to running the permeation experiment. After exposure to vacuum, the leak rate was determined by closing both the upstream and downstream volumes to vacuum and feed gases. The rate of pressure increase was determined over a period of 5 minutes after the cell had been isolated for at least one hour. Acceptable leak rates were approximately 2×10⁻⁵ torr/s or below. After an acceptable leak rate had been obtained, samples were exposed to N₂ at 15 psig until the rate of pressure increase had reached steady state (i.e., less than 3% change in pressure increase over a period of at least 30 minutes). Samples were also tested at 45 psig upstream pressure for steady state N₂ permeation. Steady state permeation values at 15 psig and 45 psig for methane and CO₂ were obtained using the test method described for N₂. Between gases the upstream and downstream volumes were evacuated using a vacuum pump for at least 16 hours at the test temperature.

Differential Scanning calorimetry (DSC): Samples weighing between 5 and 10 mg were loaded into an aluminum hermetic DSC pan. Samples were exposed to two scans, where the sample was initially heated to 200° C. at a rate of 10° C./minute. Samples were held at 200° C. for one minute and cooled to −80° C. at a rate of 10° C./minute. Thermal events such as T_{g} and Tₘ were determined from the second temperature sweep.

In PEAs there are at least three possible phases that influence pure gas permeability: soft segment (i.e., the phase that does not undergo self assembled); hard segment (i.e., the self assembled phase); and hard/soft segment interface. Generally a Tg (glass transition temperature) below 20° C. indicates a polymeric soft segment and a Tg above 20° C. indicates a hard polymeric segment. The hard segments self-assemble into crystals via hydrogen bonding. Since gases cannot diffuse or sorb into the crystalline polymer structure the bulk crystalline polymer does not participate in gas transport. Therefore, permeation through hard segment does not play a role in governing permeability in PEAs. In certain aspects of the invention it is useful to have phase separation of the soft segment.

The amide functionalities at the hard/soft segment interface are still able to interact with penetrant gas molecules, and as such contribute to gas solubility and may influence gas diffusivity around at the interface. This means the hard/soft segment interface is able to influence gas transport properties.

Both the soft segment and the hard/soft segment interface will be influenced by hard phase concentration and casting conditions. For instance, by evaporating the solvent quickly the hard and soft chain segments may not have sufficient mobility to obtain their thermodynamically most stable configuration. The differences in solvent evaporation times would influence the amount of hard phase that self-assembles and soft phase that crystallizes, and possibly influence the concentration of the hard/soft segment interface. In such systems it is desirable to maximize the hard/soft segment interface and minimize the concentration of polymer in the bulk hard phase in order to maximize the amount of polymer in a given matrix that can take part in gas transport.

It is possible that the hard and/or soft segment chain lengths may also influence gas transport properties within a family of materials with the same hard segment concentration. The hard/soft segment interface concentration is dependent on the hard segment in contact with the soft segment, which basically becomes an issue of surface area of hard phase in the film. It is possible with short chains of hard segments that the hard segment crystals will become smaller and therefore lead to a higher surface area of hard/soft segment interfaces, which would lead to a greater influence of the interface on permanent gas transport properties.

In PEAs there are generally six parameters that may influence pure gas selectivity including diffusivity selectivity in the soft segment; diffusivity selectivity in the hard segment; diffusivity selectivity in the hard/soft segment interface; solubility selectivity in the soft segment; solubility selectivity in the hard segment; and solubility selectivity in the hard/soft segment interface.

The hard segments self-assemble into crystals via hydrogen bonding between the amide groups. Since crystalline polymer does not participate in gas transport, selectivity of diffusivity and solubility in hard segments does not play a role in governing selectivity in PEAs.

PEAs are polar polymers that contain two functional groups that are expected to strongly interact with CO₂ as compared to non-polar gases. For instance, methyl acetate (a small ester molecule) exhibits CO₂/N₂ and CO₂/CH₄ solubility selectivities at 25° C. of 36 and 11, respectively, whereas nitrogen-containing molecules such as N,N-dimethylformamide and acetonitrile have pure gas CO₂/N₂ solubility selectivity at 25° C. of 65 and 64, respectively. Amide groups in a polymer would be expected to exhibit similar solubility selectivities as well. What is more, CO₂ has a smaller kinetic diameter than N₂ and CH₄, as seen in Table 1, which means that most polymers, including PEAs, should exhibit diffusivity selectivity that favors CO₂ over the non-polar gases reviewed herein.

The CO₂/CH₄ pure gas selectivities are above 13 for C2C-based materials, which is substantially above the CO₂/CH₄ solubility selectivity for small esters (i.e., 11) and similar CO₂/CH₄ solubility selectivity values of N,N-dimethylformamide and acetonitrile (i.e., 14 and 15). This result can be rationalized in part by the fact that CO₂ has a much smaller kinetic diameter than CH₄. Therefore diffusivity selectivity in all phases would be greater than 1, and the permeability selectivity of CO₂/CH₄ would be greater than the solubility selectivity values observed for small molecules of similar chemical structures.

### Working Example 1

Prior to molding, all polymer and composite samples were allowed to dry overnight (at least 16 hours) at 65° C. in at approximately 36 cmHg. Samples were compression molded into a 10 cm×10 cm×0.05 cm (4″×4″×0.02″) plaque and 5 cm×1.25 cm×0.32 cm (2″×0.5″×0.125″) bars using a Tetrahedron MPT-14 press. The molding parameters for PEA-C2C-18% based materials are listed in Table 2.

TABLE 2
Compression molding parameters for PEA-C2C18%.

| | Temperature, | Load, kg | Load ramp rate, kg/min | Time, |
|---|---|---|---|---|
| Step | ° C. | (klb) | (klb/min) | min |
| 1 | 93 | 2268 (5) | 317 × 103 (1200) | 5 |
| 2 | 93 | 4536 (10) | 317 × 103 (1200) | 10 |
| 3 | 93 | 2268 (5) | 317 × 103 (1200) | 5 |
| 4 | 24 | 450 (1) | 317 × 103 (1200) | 5 |
| 5 | End | | | |

Table 3 shows the pure gas permeability of CO₂ and CH₄ in PEA-C2C18%. With increasing pressure the CO₂ permeability increases, which is expected given the high solubility of CO₂ in polar polymers.

TABLE 3
Pure gas permeability at 20° C.

| | Permeability, barrer | | |
|---|---|---|---|
| Gas | 15 psig | 45 psig | 105 psig |
| CO₂ | 18.3 | 20.7 | 25 |
| CH₄ | 1.4 | 1.3 | 1.3 |

Table 4 shows the CO₂/CH₄ ideal gas selectivity increases with increasing CO₂ pressure. The results show the high permeability of CO₂ in PEA-C2C18% based materials along with its inherent selectivity.

TABLE 4
Pure gas selectivity at 20° C.

| Selectivity | 15 psig | 45 psig | 105 psig |
|---|---|---|---|
| CO₂/CH₄ | 13.3 | 16.4 | 18.8 |

### Working Example 2

Compositions were prepared and processed prior to casting as they were in Working Example 1.

Solution casting: 5 grams PEA-C2C18% from preparation 1 were dissolved in 5 ml chloroform/5 ml methanol solution. Samples were allowed to mix for ˜20 minutes. Once the polymer was dissolved, the solution was poured into a clean, dry, level Teflon casting plate and allowed to dry at ambient temperature and pressure in a fume hood. To slow drying, casting plate was partially covered by aluminum foil.

Table 5 presents the pure gas permeability for CO₂ and N₂ at 15 and 45 psig. Ideal gas selectivity for CO₂/N₂ are presented in Table 6.

TABLE 5
Pure gas permeability at 20° C.

| | Permeability, barrer | |
|---|---|---|
| Gas | 15 psig | 45 psig |
| CO₂ | 18.3 | 20.7 |
| N₂ | 0.31 | 0.39 |

TABLE 6
Pure gas selectivity at 20° C.

| Selectivity | 15 psig | 45 psig |
|---|---|---|
| CO₂/N₂ | 59.9 | 53.1 |

Compositions were prepared and processed prior to casting as they were in Working Example 2.

Solution casting: 5 grams of terpolymer from preparation 2 were dissolved in 20 ml chloroform solution. Samples were allowed to mix for ˜20 minutes. Once the polymer was dissolved, the solution was poured into a clean, dry, level Teflon casting plate and allowed to dry at ambient temperature and pressure in a fume hood. To slow drying, casting plate was covered with an interlocking Teflon petri dish.

Table 7 presents the pure gas permeability for CO₂ and N₂ at 15 and 45 psig. Ideal gas selectivity for CO₂/N₂ is presented in Table 8.

TABLE 7
Pure gas permeability at 35° C.

| | Permeability, barrer | |
|---|---|---|
| Gas | 15 psiq | 45 psiq |
| CO₂ | 105 | Not |
| | | Tested |
| N₂ | 4.3 | Not |
| | | Tested |

TABLE 8
Pure gas selectivity at 35° C.

| Selectivity | 15 psig |
|---|---|
| CO₂/N₂ | 24.5 |

The examples demonstrate higher CO₂ permeability than many materials that are commercially practiced for natural gas sweetening applications. As such the invention would require lower amounts of membrane surface area and as such reduce capital costs and the footprint required to complete natural gas sweetening operations. Also, these materials have high CO₂/N₂ selectivities in combination with their high CO₂ permeabilities. As such, using these materials as the selective layer in membranes for CO₂ capture from flues gases may result in high purity CO₂ streams at low capital costs.

### Working Example 3

### Supported Film Preparation

PEAC2C18% solution is prepared according to the method described above. A dry porous polysulfone layer supported by a polyesterlayer support layer is placed flat on a vacuum panel (Gardco, Pompano Beach, Fla.) attached to an operating vacuum pump. Vacuum panel is placed in an Automated Drawdown Machine II (Gardco, Pompano Beach, Fla.). A No. 5 wire wound rod (R.D. Specialties, Webster, N.Y.) was placed on the polysulfone surface in front of the drawdown bar. Polymer solution was poured in front of bar, and bar was activated to move at a speed setting of 1.5. Sample was allowed to sit for approximately 5 minutes before removal from vacuum plate.

### Mixed Gas Permeation:

Mixed gas selectivity apparatus: use a mixed gas permeation system designed as shown in the FIGURE. The apparatus 10 comprises the following components: five compressed gas cylinders 11, 12, 13, 14, and 15 of gases of N₂, ethylene (C₂H₄), 15CH₄, ethane (C₂H₆), and CO₂, respectively; four house gas sources 16, 17, 18, and 19 of gases of helium (He), hydrogen (H₂), N₂, and air, respectively; plurality of pressure regulators 21; a plurality of pressure transducers 22, capable of reading pressure from 0 pounds per square inch (psig) to 300 psig (2070 kiloPascals (kPa)); a plurality of ball valves 23; a plurality of mass flow controllers (MFC) 24; two rotameters 25; two air actuated block valves 26; coil 27 to allow gases to mix 20 together; a plurality of needle valves 28; four-way valve 29; oven 30; thermocouple 31; gas permeation cell 40; test plaque (membrane) 50; a plurality of gas lines 60; and 5890 gas chromatograph 70 (manufacturer Hewlett Packard) equipped with a flame ionization detector (FID, not shown). Oven 30 is indicated by dashed lines (“---”) and is temperature-controllable. Disposed within the oven are the thermocouple 31 and gas permeation cell 40. Horizontally 25 disposed within gas permeation cell 40 is test supported film 50, which separates upstream volume 41 from downstream volume 43 in gas permeation cell 40. Test supported film 50 has spaced-apart entrance face 51 and exit face 53. Gas lines 60 provide fluid communication between the aforementioned components as schematically illustrated in the FIGURE. Cutaways 81 and 86 are connected to each other and cutaways 82 and 87 are connected to 30 each other via separate gas lines that for convenience are not shown in the FIGURE. Air gas source 19 is connected at cutaway 89 to a gas line (not shown) to the FID (not shown) in 5890 gas chromatograph 70. Air gas source 19 can also be used to actuate the aforementioned valves. Waste gas streams are vented from four-way valve 29 or retentate gas loop 61 as indicated by arrows 90 and 91, respectively. A helium gas sweep from cylinder 16 enters volume 43 of gas permeation cell 40, sweeps permeant gas therefrom, which permeant gas has permeated through test plaque 50, to four-way valve 29 and then to either 5890 gas chromatograph 70 for compositional analysis or via arrow 90 to a vent. One each of valves 26, 28, and 29 comprise retentate gas loop 61, which receives a retained gas stream from volume 41 5 of gas permeation cell 40 and vents same via arrow 91. Employ a computer (not shown) operating Camile TG version 5.0 software for data acquisition and pressure and temperature control. For safety reasons, oven 30 has been fitted with a house nitrogen purge line (coming from bottommost rotameter 25) to purge oven 30 with nitrogen gas during permeation testing of a flammable gas.

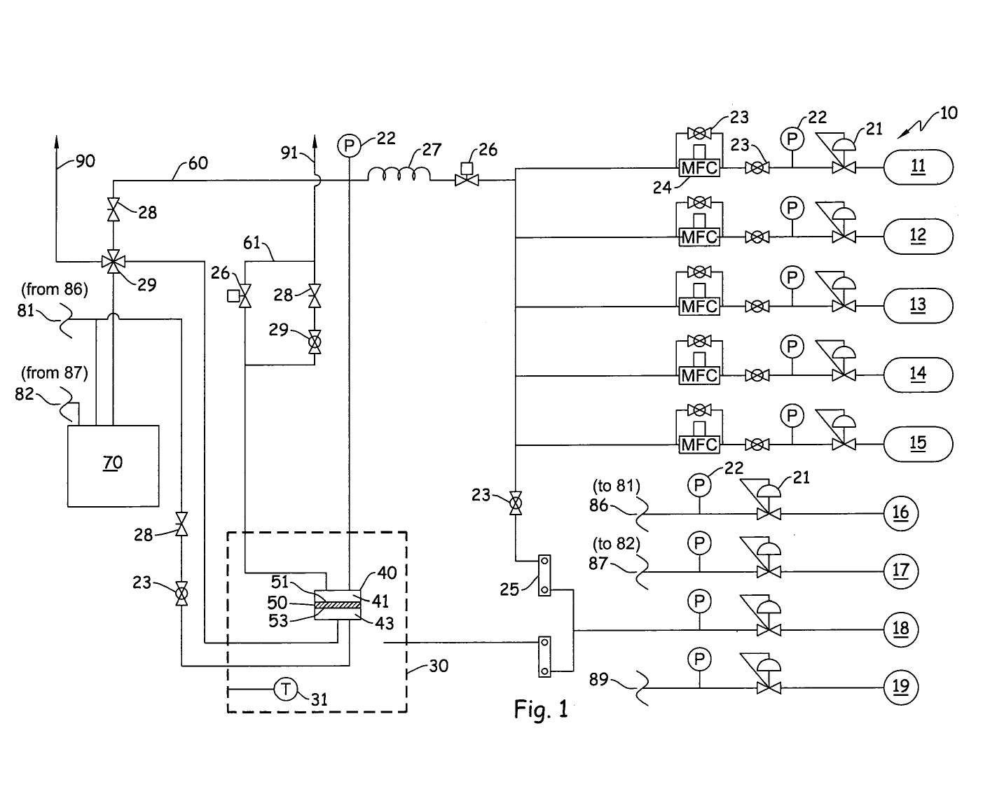

Mixed gas permeability and selectivity procedure: using apparatus 10 of FIG. 1 at 20° C. and a feed gas composed of CH₄ gas and CO₂ gas where feed gas composition can be determined using the gas chromatograph 70, dispose a test supported film (membrane) 50 (prepared by the supported film preparation method) in gas permeation cell 40, and dispose the resulting gas permeation cell containing test supported film 50 inside of oven 30. Apparatus 10 has the optionality to feed at controlled concentrations 15 from 1 to 5 gases from cylinders 11 to 15 simultaneously into volume 41 of gas permeation cell 40. When feeding from 2 to 5 gases, what enters volume 41 is a mixed gas stream. When the mixed gas stream comprises CO₂ gas from cylinder 15, the mixed gas stream comprises an embodiment of the separable gas mixture. Allow the mixed gas stream to flow past into volume 41 and contact entrance face 51 of test plaque (membrane) 50. Remove retained gases to retentate 20 gas loop 61. Sweep permeant gas(es) (i.e., gases that have permeated through test plaque 50) away from the exit face 53 of test supported film (membrane) 50 and out of volume 43 of cell 40 using a He gas stream flowing at 5 milliliters per second (mL/s). The He gas sweeping allows for the test supported film (membrane) 50 to effectively operate as if its exit face 53 were exposed to a vacuum. Separately send some of permeation-resistant gas from volume 41 and swept permeant gas from volume 43 to 25 5890 gas chromatograph 70 to determine compositions thereof. Between testing with the different mixed gases, evacuate the upstream and downstream volumes in the cell using a vacuum pump for at least 16 hours at 20° C. Calculate mixed gas selectivities as follows.

Mixed gas selectivity, α_{A/B}, can be determined as follows:

$${α}_{A / B} = \frac{{x}_{A} / {y}_{A}}{{x}_{B} / {y}_{B}} \qquad ( 6 )$$

where x_{A} and x_{B} are the molar concentrations of component A and B in the permeate. y_{A} and y_{B} are the molar concentrations of component A and B in the feed, respectively.

PEAC2C18% cast on a porous polysulfone layer supported by a polyester layer supports exhibits mixed gas selectively CO₂/CH₄ of 21.5 at 1 atm CO₂ partial pressure in a 50:50 CO₂:CH₄ feed stream at 21° C. What is more, the mixed gas selectivity remains elevated over the CO₂ partial pressure range tested, i.e., CO₂/CH₄ mixed gas selectivity is 15 at 6.7 atm CO₂ partial pressure in a feed that is 60:40 CO₂:CH₄ at 21° C.

### Working Example 4

Preparation 3: preparing dimethyl ester of 6,6′-(1,2-ethanediyldiimino)bis[6-oxo-hexanoic acid](“A2A diamide diester”):

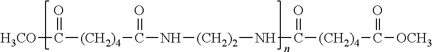

Stir under a nitrogen gas atmosphere titanium (IV) butoxide (0.92 g, 2.7 mmol), ethylene diamine (15.75 g, 0.262 mol), and dimethyl adipate (453.7 g, 2.604 mol) in a 3-neck, 1 L round bottom flask and heat as follows: 2.0 hours to/at 50° C.; then 2.0 hours to/at 60° C.; then 2.0 hours to/at 80° C.; and then overnight at 100° C. Cool flask to room temperature. Add approximately 200 mL of cyclohexane to the reaction flask with agitation to give a slurry; filter and collect. (a) Wash filtercake with about 50 mL of cyclohexane, then triturate with about 320 mL cyclohexane, refilter, and rewash second filter cake with about 50 mL cyclohexane. Dry solids overnight in a 50° C. vacuum oven. (b) Repeat (a) and dry solids to constant weight in a 50° C. vacuum oven under full pump vacuum to give 54.2 grams of the A2A diamide diester of Preparation 5 (lacks unreacted dimethyl adipate), wherein n is approximately 1.

Preparation 4: preparing a premodification MSA material that is a polyesteramide having calculated composition of 69.6 wt % butylene adipate repeat units and 30.4 wt % butylene A2A repeat units (PBA/PBA2A, 69.9/30.4). Stir under a nitrogen gas atmosphere titanium 5 (IV) butoxide (0.131 gram (g). 0.385 millimole (mmol)), A2A diamide diester (16.95 g, 49.21 mmol, Preparation 3), dimethyl adipate (36.33 g, 0.2086 mol), and 1,4-butanediol (34.84 g, 0.3866 mole (mol)) in a 1-neck 250 milliliter (mL) sized round bottom flask equipped with Vigreux column and heat in a temperature-controlled salt bath at 160° C. with bath temperature raised to a setpoint of 175° C. for 10 total time of 1.9 hours. Change receiver with applying following vacuums, times: 450 Torr (60 kilopascals (kPa)), 5 minutes; 100 Torr (13 kPa), 5 minutes; 50 Torr (6.7 kPa), 10 minutes; 40 Torr (5.2 kPa), 10 minutes; 30 Torr (3.9 kPa), 10 minutes; 20 Torr (2.6 kPa), 10 minutes; 10 Torr (1.3 kPa), 90 minutes. Change receiver and place apparatus under full vacuum of about 0.3 Torr at 175° C. for a total of 2 hours. Cool flask contents to give the polyesteramide of Preparation 6 having an 15 Inherent Viscosity=0.22 dL/g; chloroform/methanol (1/1, weight per weight (wt/wt)); 30.0° C., 0.5 g/dL). Mn is 5110 g/mol (1H-NMR).

Preparation 5: preparing a premodification MSA material that is a polyetheresteramide having a calculated composition of 27.3 wt % butylene adipate repeat units, 34.4 wt % C2C diamide diol adipate, 23.3 wt % poly(ethylene glycol-block-propylene glycol-block-5 polyethylene glycol adipate repeat units, and 15.0 wt % polyethylene glycol adipate repeat units (PBA/PC2CA/P(PPO)A/PEGA, 27.3/34.4/23.3/15). Stir under a nitrogen gas atmosphere titanium (IV) butoxide (0.083 gram (g), 0.24 millimole (mmol)), purified C2C amide diol (18.67 g, 64.74 mmol, Preparation 1), poly(ethylene glycol-block-poly(propylene glycol)-block-poly(ethylene 10 glycol), 10 wt % polyethylene glycol, Mn 2800 g/mol (16.81 g, 6.00 mmol), CARBOWAX™ Sentry polyethylene glycol 600 NF, Mn 621 g/mol (9.56 g, 15.4 mmol), dimethyl adipate (32.82 g, 0.1884 mol), and 1,4-butanediol (17.68 g, 0.1965 mole (mol)) in a 1-neck 250 milliliter (mL) sized round bottom flask fitted with Vigreux column and heat in a temperature-controlled salt bath at 160° C. for 45 minutes. Then raise bath temperature to a setpoint of 175° C. and hold for time of 70 minutes, 15 change receiver with applying following vacuums, times: 450 Torr (60 kilopascals (kPa)), 5 minutes; 100 Torr (13 kPa), 5 minutes; 50 Torr (6.7 kPa), 5 minutes; 40 Torr (5.2 kPa), 5 minutes; 30 Torr (3.9 kPa), 5 minutes; 20 Torr (2.6 kPa), 5 minutes; 10 Torr (1.3 kPa), 125 minutes. Change receiver and place apparatus under full vacuum of about 0.5 Torr at 175° C. for a total of 2.1 hours. Cool flask contents to give the polyetheresteramide of Preparation 4 having an Inherent Viscosity=20 0.22 deciliters per gram (dL/g; chloroform/methanol (1/1, weight per weight (wt/wt)); 30.0° C., 0.5 g/dL). By carbon-13 NMR, Mn is 4974 g/mol.

Preparation 6: preparation of MSA material that is a polyesteramide (PEA) comprising 50 mole percent of ethylene-N,N′-dihydroxyhexanamide (C2C) monomer (the MSA material is generally designated as a PEA-C2C50%)

Step (a) Preparation of the Diamide Diol, Ethylene-N,N′-dihydroxyhexanamide (C2C) Monomer

The C2C diamide diol monomer is prepared by reacting 1.2 kg ethylene diamine (EDA) with 4.56 kilograms (kg) of ε-caprolactone under a nitrogen blanket in a stainless steel reactor equipped with an agitator and a cooling water jacket. An exothermic condensation reaction between the ε-caprolactone and the EDA occurs which causes the temperature to rise gradually to 80 degrees Celsius (° C.). A white deposit forms and the reactor contents solidify, at which the stirring is stopped. The reactor contents are then cooled to 20° C. and are then allowed to rest for 15 hours. The reactor contents are then heated to 140° C. at which temperature the solidified reactor contents melt. The liquid product is then discharged from the reactor into a collecting tray. A nuclear magnetic resonance study of the resulting product shows that the molar concentration of C2C diamide diol in the product exceeds 80 percent. The melting temperature of the C2C diamide diol monomer product is 140° C.

Step (b): Contacting C2C with Dimethyl Adipate (DMA)

A 100 liter single shaft Kneader-Devolatizer reactor equipped with a distillation column and a vacuum pump system is nitrogen purged, and heated under nitrogen atmosphere to 80° C. (based on thermostat). Dimethyl adipate (DMA; 38.324 kg) and C2C diamide diol monomer (31.724 kg) are fed into the kneader. The slurry is stirred at 50 revolutions per minute (rpm).

Step (c): Contacting C2C/DMA with 1,4-butanediol, Distilling Methanol and Transesterification

1,4-Butanediol (18.436 kg) is added to the slurry of Step (b) at a temperature of about 60° C. The reactor temperature is further increased to 145° C. to obtain a homogeneous solution. Still under nitrogen atmosphere, a solution of titanium(IV)butoxide (153 g) in 1.380 kg 1,4-butanediol is injected at a temperature of 145° C. into the reactor, and methanol evolution starts. The temperature in the reactor is slowly increased to 180° C. over 1.75 hours, and is held for 45 additional minutes to complete distillation of methanol at ambient pressure. 12.664 kilograms of methanol are collected.

Step (d): Distilling 1,4-butanediol and Polycondensation to Give PEA-C2C50%

Reactor dome temperature is increased to 130° C. and the vacuum system activated stepwise to a reactor pressure of 7 mbar (0.7 kiloPascals (kPa)) in 1 hour. Temperature in the kneader/devolatizer reactor is kept at 180° C. Then the vacuum is increased to 0.7 mbar (0.07 kPa) for 7 hours while the temperature is increased to 190° C. The reactor is kept for 3 additional hours at 191° C. and with vacuum ranging from 0.87 to 0.75 mbar. Then the liquid Kneader/Devolatizer reactor contents are discharged at high temperature of about 190° C. into collecting trays, the polymer is cooled to room temperature and grinded. Final product is 57.95 kg (87.8% yield) of melt viscosities 8625 mPas at 180° C. and 6725 mPas at 190° C.

TABLE 9
Mixed gas CO₂/CH₄ selectivity for supported films at
15 psig feed stream, 50/50 CO₂/CH₄ concentration at 21° C.

| | Selective layer | CO₂/CH₄ mixed |
|---|---|---|
| Example | on support | gas selectivity |
| Preparation 1 | C2C-18 | 21.6 |
| Preparation 4 | A2A | 21.5 |
| Preparation 5 | PBA/PC2CA/ | 21.84 |
| | P(PPO)A/PEGA | |
| Preparation 6 | C2C-50 | 22.5 |

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

The claimed invention is:

1. A method of extracting an acidic gas from a gas stream by contacting said gas stream with a polymer, wherein said polymer comprises a macromolecular self assembling polymeric material, said method comprising the steps of:
a.) contacting said polymer with said gas stream; and
b.) extracting said acidic gas from said gas stream.

2. The method of claim 1, wherein said polymer comprises a film.

3. The method of claim 1, wherein said polymer comprises a multi film sheet.

4. The method of claim 1, wherein said acidic gas comprises one or more gaseous species selected from the group consisting of carbon monoxide, carbon dioxide, sulfur oxide, sulfur dioxide, sulfur trioxide, hydrogen sulfide and mixtures thereof.

5. The method of claim 1, additionally comprising the steps of:
a.) synthesizing said polymer;
c.) rendering said polymer into a film;
d.) contacting said gas mixture with said film; and
e.) extracting said acidic gas from said gas stream using said polymeric film.

6. The method of claim 1, wherein said gas stream comprises a flue or exhaust gas.

7. The method of claim 1, wherein said gas stream comprises a well head gas.

8. The method of claims 1, wherein said polymeric film has a C0₂/CH selectivity above 4 at a C0₂ permeability above 10 barrer.

9. The method of claims 1, wherein the molecularly self-assembling material is selected from the group consisting of a polyester-amide, polyether-amide, polyester-urethane, polyether-urethane, polyether-urea, polyester-urea, or a mixture thereof.

10. The method of claim 1, wherein the molecularly self-assembling material comprises self-assembling units comprising multiple hydrogen bonding arrays.

11. The method of claim 10, wherein the multiple hydrogen bonding arrays have an association constant K (assoc) of greater than 10 3 M″ 1.

12. The method of claim 10, wherein the multiple hydrogen-bonding arrays comprise at least 4 donor-acceptor hydrogen bonding sites per self-assembling unit.

13. The method of claim 10, wherein the multiple hydrogen-bonding arrays comprise an average of 2 to 8 donor-acceptor hydrogen bonding sites per self-assembling unit.

14. The method of any of the preceding claims, wherein the molecularly self-assembling material comprises repeat units of formula I: 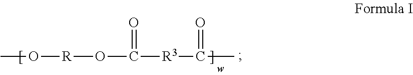
and at least one second repeat unit selected from the ester-amide units of Formula II and III: 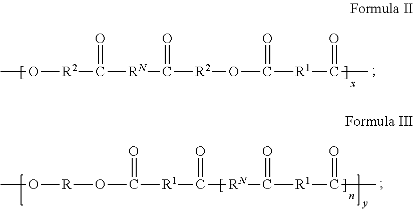
and the ester-urethane units of Formula IV: 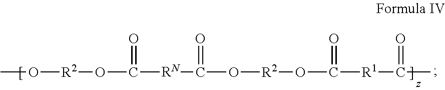
or combinations thereof wherein:
R is at each occurrence, independently a C₂-C₂₀ non-aromatic hydrocarbylene group, a C₂-C₂o non-aromatic heterohydrocarbylene group, or a polyalkylene oxide group having a group molecular weight of from about 100 grams per mole to about 5000 grams per mole;
R¹ at each occurrence independently is a bond or a Ci-C₂₀ non-aromatic hydrocarbylene group;
R² at each occurrence independently is a C1-C20 non-aromatic hydrocarbylene group;
R^{N} is —N(R³)—Ra—N(R³)—, where R³ at each occurrence independently is H or a Ci-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
w represents the ester mol fraction of Formula I, and x, y and z represent the amide or urethane mole fractions of Formulas II, III, and IV, respectively, where w+x+y+z=, and 0<w<1, and at least one of x, y and z is greater than zero but less than 1.

15. The method of claim 1, wherein the molecularly self assembling material is a polymer or oligomer of Formula II or III: 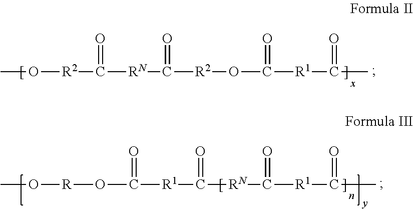
wherein
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a CrC₂₀ non-aromatic hydrocarbylene group;
R^{N} is —N(R³)—Ra—N(R³)—, where R3 at each occurrence independently is H or a Ci-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
x and y represent mole fraction wherein x+y=1, and 0<x≦1, and 0<y 1.

16. The method of claim 1, wherein the number average molecular weight (Mn) of the molecularly self-assembling material is between about 1000 grams per mole (g/mol) and about 50,000 g/mol.

17. The method of claim 1, wherein the number average molecular weight of the molecularly self-assembling material is less than 5,000 g/mol.
